(19) United States
(12) Patent Application Publication
(10) Pub. No.: US 2002/0195343 A1
(43) Pub. Date: Dec. 26, 2002

(54) Microfabricated separation device employing a virtual wall for interfacing fluids

(75) Inventors: Sebastian Bohm, Bloemendaal (NL); John Gilbert, Brookline, MA (US)

Correspondence Address: LAHIVE & COCKFIELD, 28 STATE STREET, BOSTON, MA, 02109, US

(73) Assignee: Coventor, Inc., Cary, NC

(21) Appl. No.: 10/057,354

(22) Filed: Jan. 24, 2002

Related U.S. Application Data
(60) Provisional application No. 60/299,515, filed on Jun. 20, 2001.

(51) Int. Cl. G01N 27/26; G01N 27/447

(52) U.S. Cl. 204/453; 204/604

(57) ABSTRACT

A fluid interface port in a separation device for separating a sample into different components is provided. The separation device includes an array of separation channels and the fluid interface port comprises an opening formed in the side wall of a separation channel sized and dimensioned to form a virtual wall when the separation channel is filled with a separation medium. The fluid interface port is utilized to introduce a liquid sample into the separation medium. The fluid interface ports formed in the array of separation channels are organized into one or more sample injectors. A cathode reservoir is multiplexed with one or more separation channels. To complete an electrical path, an anode reservoir which is common to some or all separation channels is also provided.

### REFERENCE TO RELATED APPLICATIONS

This application claims priority to U.S. Provisional Patent Application No. 60/299,515 filed Jun. 20, 2001, and is related to Attorney Docket No. CVZ-001a, entitled “Microfluidic System Including a Virtual Wall Fluid Interface Port for Interfacing Fluids with the Microfluidic System”, filed Dec. 21, 2001; Attorney Docket No. CVZ-001b, entitled “Microfluidic System Including a Virtual Wall Fluid Interface Port for Interfacing Fluids with the Microfluidic System”, filed Dec. 21, 2001; Attorney Docket No. CVZ-001, entitled “Microfluidic System Including a Virtual Wall Fluid Interface Port for Interfacing Fluids with the Microfluidic System”, filed Dec. 21, 2001; Attorney Docket No. CVZ-002, entitled “Microfabricated Two-Pin Liquid Sample Dispensing System”, filed Dec. 21, 2001; Attorney Docket No. CVZ-003, entitled “Small Molecule Substrate Based Enzyme Activity Assays”, filed Dec. 21, 2001; and Attorney Docket No. CVZ0-005, entitled “Droplet Dispensing System”, filed Dec. 21, 2001. The contents of the foregoing patent applications are herein incorporated by reference. The contents of all references, issued patents, or published patent applications cited herein are expressly incorporated by reference.

### BACKGROUND OF THE INVENTION

The present invention relates an apparatus and method for performing a separation of a sample in a microfabricated system. More particularly, the invention relates to fluidic interface ports for providing fluid interfacing in a microfabricated capillary array separation device.

In many diagnostic and gene identification procedures, such as gene mapping, gene sequencing and disease diagnosis, deoxyribonucleic acid (DNA), ribonucleic acid (RNA) or proteins are separated according to their physical and chemical properties. In addition to DNA, RNA or proteins, other small molecule analytes may also need to be separated.

One electrochemical separation process is known as electrophoresis. In this process, molecules are transported in a capillary or a separation channel which is connected to a buffer-filled reservoir. An electric field in the range of kilovolts is applied across both ends of the channel to cause the molecules to migrate. Samples are typically introduced at a high potential end and, under the influence of the electric field, move toward a low potential end of the channel. After migrating through the channel, the separated samples are detected by a suitable detector.

Many methods have been described for the interfacing of fluids, e.g., samples, analytes, reagents, precursors for synthesis and buffers, towards, within or between electrophoretic systems. Generally, electrokinetic injection is applied for the introduction of liquids in capillary electrophoresis columns implemented on chip-like devices. In this method, liquid is pumped from a first well towards the separation channel for electrophoretic separation by the application of a high driving voltage between the first well and a second well located downstream. Due to the charged inner surfaces of the sample channel walls, an electroosmotic liquid flow is induced, which pumps liquid out of the first well and into the targeted sample channel. This method is referred to as ‘electrokinetic injection’ and has some specific disadvantages. One disadvantage is that if a large number of liquids needs to be handled, for instance in high-throughput synthesis and screening applications, a large number of wells are required to be integrated on the microfluidic device. The relatively large footprint of a typical well when compared to the sample separation channels in which the actual chemical operation is performed, takes up a dominating portion of the chip surface. As the costs of microfluidic chips strongly depends on the chip surface, the required integration of wells renders this liquid injection scheme unattractive for high-throughput synthesis and screening applications.

For example, U.S. Pat. No. 6,143,152 describes an electrophoretic system comprising a capillary array electrophoresis micro-plate including an array of sample reservoirs for introducing a sample to the electrophoretic system via electrokinetic injection. Liquid is pumped from a first well towards a separation channel for electrophoretic separation by the application of a high driving voltage between this well and a second well located downstream. Due to the charged inner surfaces of the channel walls, an electroosmotic liquid flow is induced pumping liquid out of the first well into the targeted separation channel. A drawback of the system described in the '152 patent is the relatively large footprint of the sample reservoir (about 5 mm diameter) when compared to the channels in which the actual chemical operation is performed (about 50 μm diameter), resulting in a low injection efficiency. Only a small portion of the sample supply in the sample reservoir is actually introduced into the separation channel, leading to significant waste and inefficiency.

### SUMMARY OF THE INVENTION

The invention provides a separation device, such as a capillary array electrophoresis (CAE) micro-plate, including an array of capillaries or separation channels and one or more fluid interface ports for introducing and removing fluids from the separation channels. The fluid interface port of the illustrative embodiment directly interfaces the separation channels with the surrounding environment and is defined by an aperture formed in the side wall of one of the separation channels. The aperture forms a virtual wall when the separation channel is filled with a liquid separation medium. The aperture has suitable cross sectional dimensions such that capillary forces retain the separation medium within the separation channel. The virtual wall is defined by the meniscus of the separation medium in the opening, which essentially replaces the side wall of the separation channel so as to not substantially affect or influence fluid flow through the sample channel. A cathode reservoir is multiplexed with one or more separation channels. An anode reservoir, which is common to some or all separation channels, is also provided on the micro-plate to provide an electrical path through the separation channels.

According to one aspect, a separation device for separating a sample is provided. The separation device comprises one or more anode reservoirs, a plurality of separation channels connected to the anode reservoirs and having an interior bounded by a side wall, one or more fluid interface ports formed in the side wall of one of said separation channel to provide access to the interior of the separation channel and at least one cathode reservoir multiplexed with two or more of the separation channels. A fluid disposed in the interior of the separation channel forms a virtual wall at the fluid interface port.

According to another aspect of the invention, a separation device for separating a sample is provided. The separation device comprises an array of microfabricated separation channels, an array of fluid interface ports, an array of cathode reservoirs and an array of anode reservoirs. The separation channels have an interior bounded by a side wall and are formed at a surface of a first microfabricated substrate and a corresponding surface of a second substrate bonded to the surface of said first substrate. Each of the separation channels includes a first end and a second end. The fluid interface ports are formed in the side walls of the separation channels to provide access to the interiors of the separation channels. A fluid disposed in the interior of the separation channel forms a virtual wall at each of the fluid interface ports in the array. The array of cathode reservoirs is connected to the first end of each of the separation channels. At least one anode reservoir is connected to the respective second ends of at least two of the separation channels.

According to another aspect of the invention, a separation device, comprising a substrate, a plurality of separation channels formed in said substrate, a plurality of fluid interface ports and an anode reservoir, is provided. The fluid interface ports are formed in the side walls of said separation channels to provide access to the interior of the separation channel and a separation medium disposed in the interior of the separation channel forms a virtual wall at the fluid interface port. Each separation channel of the plurality of separation channels is in fluid communication with at least one dedicated fluid interface port. The anode reservoir is multiplexed to two or more of the plurality of separation channels.

According to yet another aspect of the invention, a separation device, comprising a substrate, a plurality of separation channels formed in said substrate, a plurality of fluid interface ports and a cathode reservoir is provided. The fluid interface ports are formed in the side walls of the separation channels to provide access to the interior of the separation channel. A separation medium disposed in the interior of the separation channel forms a virtual wall at the fluid interface port. Each separation channel of the plurality of separation channels is in fluid communication with at least one dedicated fluid interface port. The cathode reservoir is multiplexed to two or more of the plurality of separation channels.

According to another aspect, a method for injecting a liquid sample through a separation device is provided. The method comprises connecting a cathode reservoir to respective first ends of two or more separation channels, connecting an anode reservoir to respective second ends of two or more of said separation channels, forming a droplet from the liquid sample, directing the droplet to a virtual wall formed by a separation medium in a fluid interface port formed in a side wall of a separation channel and applying a voltage to the fluid interface port to draw the sample into the separation channel.

According to another aspect of the invention, a method of forming a separation device for separating a sample into different components is provided. The method comprises the steps of forming a plurality of separation channels defined by an interior bounded by a side wall in the separation device, forming a plurality of fluid interface ports in the side walls of said separation channels to provide access to the interior of the separation channels, and connecting an anode reservoir to two or more of the plurality of separation channels. Each fluid interface port forms a virtual wall when the separation channels are filled with a separation medium.

According to a final aspect of the invention, a method of forming a separation device for separating a sample into different components is provided. The method comprises the steps of forming a plurality of separation channels in the separation device defined by an interior bounded by a side wall, forming a plurality of fluid interface ports in the side walls of said separation channels to provide access to the interior of the separation channels and connecting a cathode reservoir to two or more of the plurality of separation channels. Each fluid interface port forms a virtual wall when the separation channels are filled with a separation medium.

### BRIEF DESCRIPTION OF THE DRAWINGS

FIG. 1 is a capillary array electrophoresis (CAE) micro-plate of the prior art.

FIG. 2 is a schematic illustration of the sample injector of FIG. 1.

FIG. 3 is a capillary array electrophoresis (CAE) micro-plate according to an illustrative embodiment of the present invention.

FIG. 4A is a cross-sectional side view of a separation channel including a fluid interface port for receiving a liquid droplet into the separation channel.

FIG. 4B is a cross-sectional view perpendicular through the separation channel of FIG. 4A at the position of the fluid interface port.

FIG. 4C is a cross-sectional view of a separation channel having a virtual wall according to the teachings of the invention, illustrating the composition of the liquid inside the separation channel directly after receiving a droplet.

FIG. 4D is a cross-sectional view of a separation channel having a virtual wall according to an alternate embodiment of the invention.

FIG. 4E is a cross-sectional view of a separation channel having a virtual wall according to an alternate embodiment of the invention, including a covering layer.

FIG. 4F is a cross-sectional view of a separation channel having an array of apertures forming virtual walls.

FIG. 4G illustrates the introduction of a liquid into the separation channel shown in FIG. 4F.

FIG. 5 is an illustration of a laser excited galvo-scanner in conjunction with the CAE micro-plate of FIG. 3 according to an illustrative embodiment of the present invention.

FIG. 6 is a capillary array electrophoresis (CAE) micro-plate layout according to an alternate embodiment of the present invention.

FIG. 7 is a capillary array electrophoresis (CAE) micro-plate layout according to another embodiment of the present invention.

FIG. 8 is an enlarged view of a perimeter portion of the CAE micro-plate layout of FIG. 7.

FIG. 9 is an enlarged view of a center portion of the CAE micro-plate layout of FIG. 7.

### DETAILED DESCRIPTION OF THE INVENTION

The present invention provides an improved fluidic interface for introducing fluids to and removing fluids from a separation channel in a separation device. The present invention significantly improves controllability over fluid samples, increases injection efficiency, increases throughput and reduces waste by utilizing an opening defining a virtual wall in a side wall of a separation channel to introduce and remove a fluid sample. The present invention will be described with reference to an illustrative embodiment comprising a capillary array electrophoresis micro-plate. One skilled in the art will recognize that the invention is not limited to an electrophoretic system and may be implemented in any suitable separation system, including, but not limited, to an electrochromatographic system, a pressure-driven chromatographic system and an isoelectric focussing system.

One or more of the illustrative embodiments provides fluidic interfacing with a capillary array electrophoresis micro-plate. With the present invention, a relatively large number of chemical operations can be performed on a small chip surface, thereby enabling the cost effective implementation and efficient operation of massively parallel synthesis and analysis systems. The present invention further significantly reduces the required liquid volume for interfacing, resulting in a considerable reduction of consumption of chemicals, as well as the reduction of chemical waste. The present invention further provides methods and systems for the injection of liquids with near 100% injection efficiency and provides methods and systems for the injection of liquids which do not electrochemically pollute the handled liquids. The present invention presents methods and systems for the fast repetitive injection of liquids in an electrokinetically driven system, allowing high throughput synthesis, screening and analysis applications. The present invention further allows for galvanic separation of the liquid to be injected with the electrokinetically operated microfluidic system.

As used herein, “separation” refers to the movement of particles through a fluid in a separation channel under the influence of a constant or varying electric field or transport force acting across a first end and a second end of the channel and causing separation of the particles in the fluid based on their mobility under those conditions. Examples of such a separation include, but are not limited to, electrophoresis, electrochromatography, pressure driven chromatography and isoelectric focusing.

As used herein, “electrophoretic system” refers to a system suitable for performing electrophoresis on a sample.

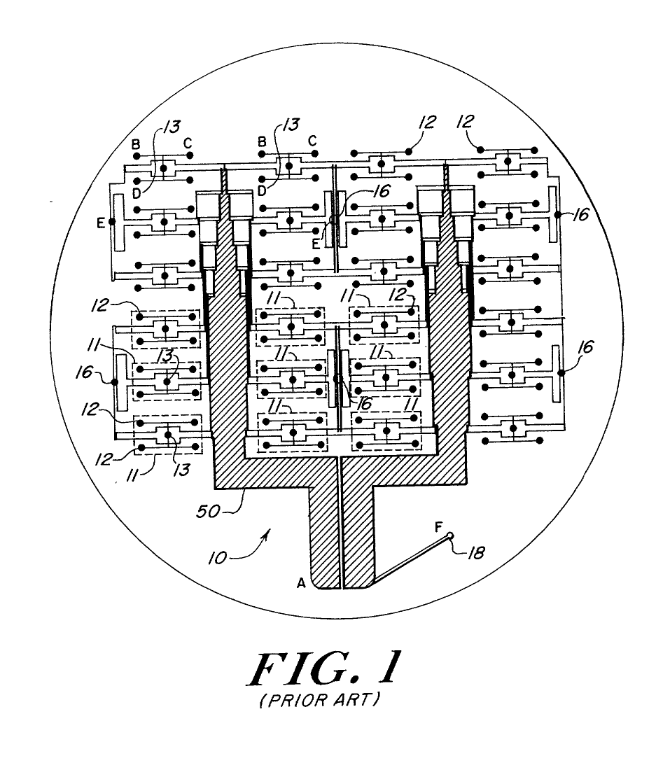

FIG. 1 illustrates a prior capillary array electrophoresis (CAE) micro-plate 10 described in U.S. Pat. No. 6,143,152, the contents of which are herein incorporated by reference. The micro-plate 10 has an array of capillaries or separation channels 50 etched thereon. As shown in FIG. 1, the prior art micro-plate 10 includes 48 individual separation channels etched in a 150-micron (μm) periodic array. The micro-plate 10 further includes an array of sample injectors 11 connected to the separation channels 50 for introducing a sample to the micro-plate 10. Each sample injector 11 includes a plurality of sample reservoirs 12, each holding a supply of sample to be separated, and a waste reservoir 13 for collecting waste from the separation channels 50. The micro-plate 10 includes a plurality of cathode reservoirs 16 multiplexed with one or more of the separation channels and an anode reservoir 18, which is common to some or all of the separation channels 50, to complete an electrical path through the separation channels 50. The injectors 11 in the micro-plate are grouped together and connected to a corresponding cathode reservoir 16.

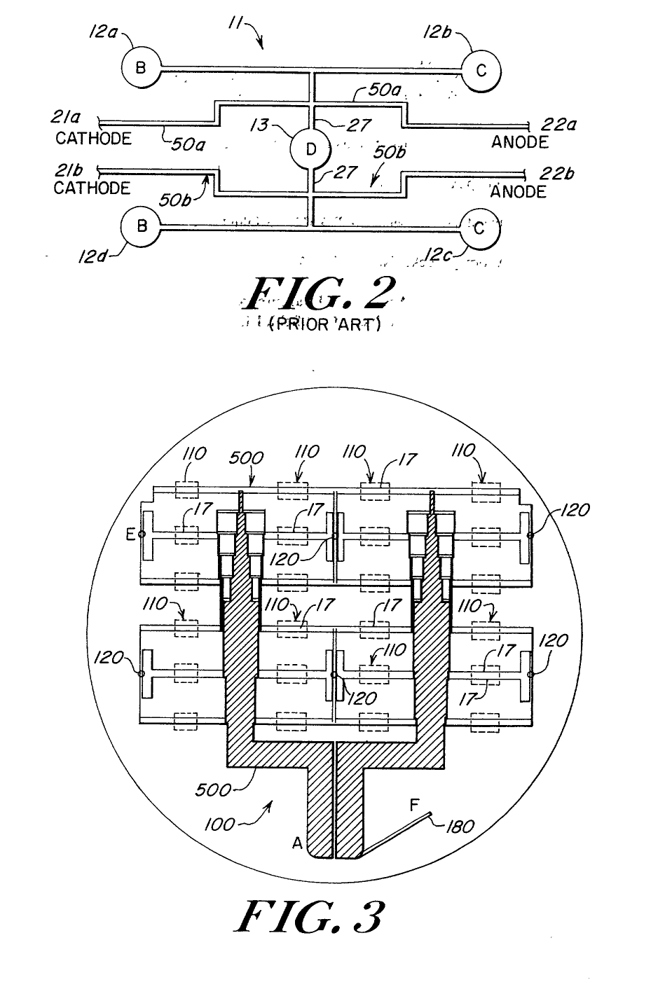

FIG. 2 illustrates the details of the sample injector 11 of the micro-plate 10 shown in FIG. 1. The sample injector 11 of the '152 reference includes a first and second separation channel 50a and 50b in communication with sample reservoirs 12a, 12b, 12c and 12d holding a supply of the samples to be separated. The first and second separation channels 50a, 50b in the injector 11 are connected to a waste reservoir 13 for collecting waste by a cross channel 27. As shown, the sample injector 11 further includes a cathode end 21a and an anode end 22a. The cathode and anode ends are disposed at opposite ends of the first separation channel 50a. A second cathode end 21b is connected to a second anode end 22b by the second separation channel 50b that is also connected to the waste reservoir 13.

To load a band of sample from a sample reservoir 12 and into a separation channel 50, an injection voltage is applied between the sample reservoir 12 and the waste reservoir 13 to draw a sample through the cross channel 27. After the sample band is loaded into the cross channel 27, a separation voltage of about 3700 volts (300 V/cm) is applied between the cathode end 21 and the anode end 22 of the injector 11. This causes the electrophoretic separation of the sample. In addition, a back-bias of the potential between the sample reservoir 12 and the injection waste reservoir 13 is applied. The back biasing voltage is about 720 volts. The back-biasing operation clears excess samples from the injection cross-channel 27, and results a 100-micron sized sample band.

The configuration shown in FIGS. 1 and 2 has significant limitations and disadvantages. As shown, the sample injector requires a fairly complicated and sizeable structure that is difficult and expensive to manufacture. A large portion of the plate 10 is dedicated to sample injection, rather than for the actual electrophoresis, resulting in wasted space. Furthermore, the illustrated configuration results in wasted sample, as a larger amount of sample is inherently introduced from the sample reservoir to the separation channel than is necessary and must be reduced by separation. To achieve the required narrow band of sample, the plate of the prior art requires a sample injection circuit to pull sample from the sample reservoir, separate the sample to remove excess sample and direct the excess sample to a waste reservoir. Thus, the micro-plate of the prior art results in significant amounts of wasted sample, as well as inefficient utilization of space and resources.

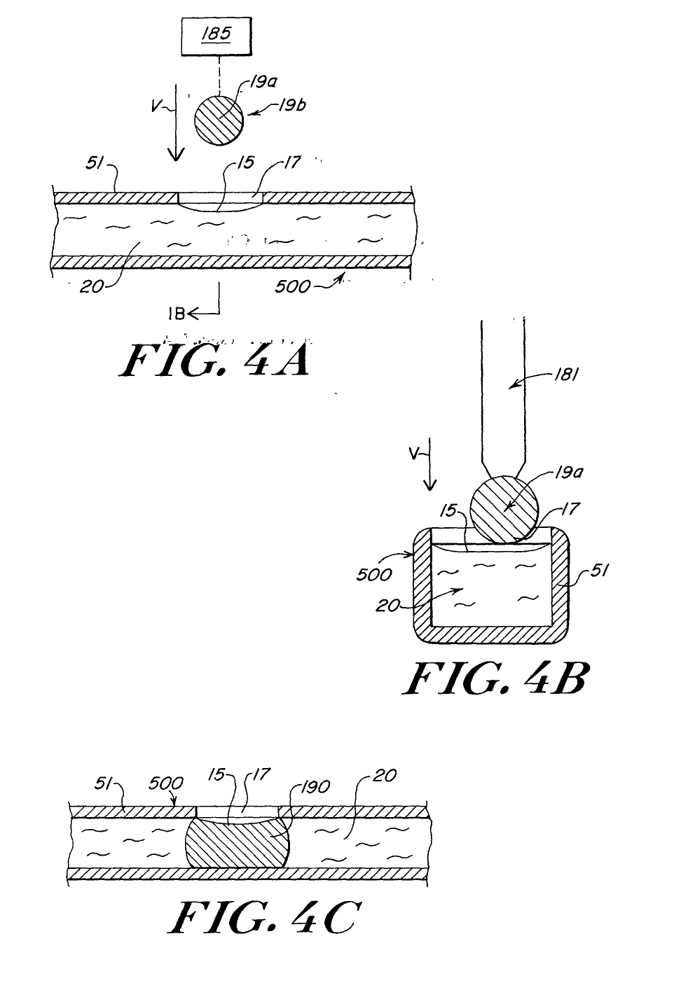

According to the illustrative embodiment of the present invention, an improved separation device is provided, wherein samples are directly injected into a separation channel via a fluid interface port formed in a side wall of the separation channel, rather than an injector group. FIG. 3 illustrates separation device according to an illustrative embodiment of the present invention, illustrated as a capillary array electrophoresis (CAE) micro-plate 100. As used herein, “fluid interface port” refers to a structure in an separation system, such as an aperture formed in a separation channel that provides fluid access between the interior and the exterior of the separation channel. The fluid interface port is formed in an injection region 110 of the separation channel and is utilized to introduce fluids and other material to the corresponding separation channel and/or to remove fluid and/or other material from the corresponding separation channel.

According to the illustrative embodiment, the micro-plate 100 includes an array of separation channels 500, which are defined by a side wall having any suitable shape enclosing at least a portion of the interior of the channel. The separation channels 500 have cross-sectional dimensions in the range between about 1.0 μm and about 250 μm, preferably between about 25 μm and about 150 μm and most preferably between about 50 μm and about 100 μm. One of ordinary skill in the art will be able to determine an appropriate volume and length of the separation channel. The separation channels 500 can have any selected shape or arrangement, examples of which include a linear or non-linear configuration and a U-shaped configuration. The micro-plate 100 may be formed from any suitable material, including, but not limited to glass, plastic and silicon. The capillary electrophoresis micro-plate 100 may comprise any suitable number of separation channels 500 for separating a sample into different components under the influence of an applied electric field. The micro-plate 100 includes a plurality of cathode reservoirs 120 multiplexed with one or more of the separation channels and an anode reservoir 180, which is common to some or all of the separation channels 500, to complete an electrical path through the separation channels 500. The separation channels 500 in the micro-plate 100 are grouped together and connected to a corresponding cathode reservoir 120.

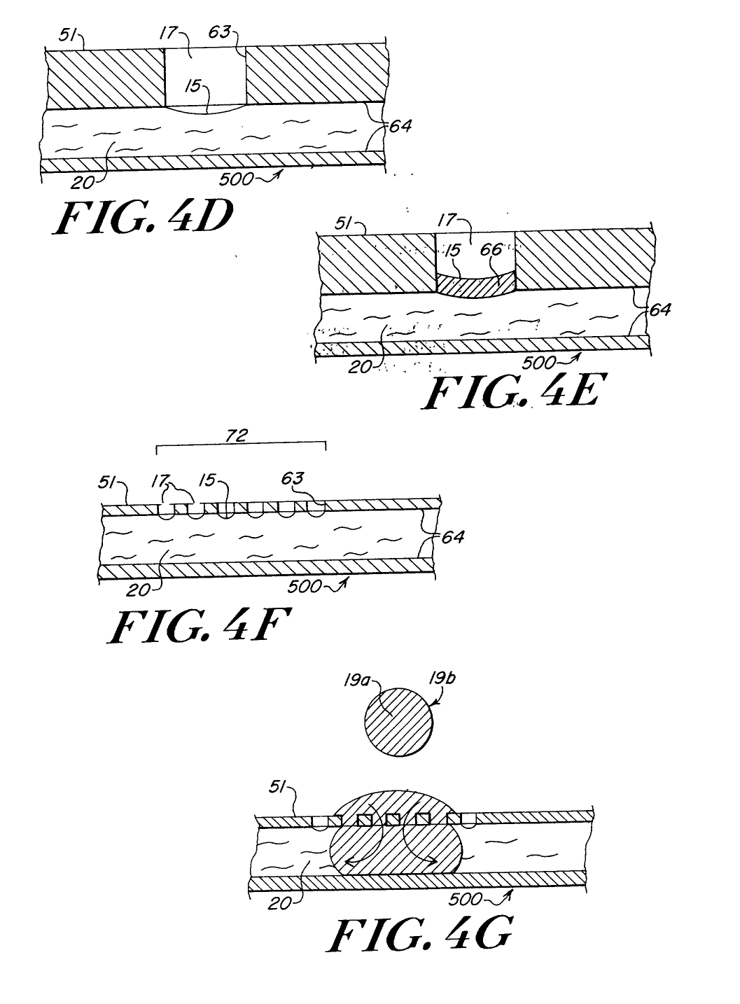

According to the illustrative embodiment, the fluid interface port 17 in the injection region 110 of the separation channel 500, shown in detail in FIG. 4A, comprises an aperture formed in the side wall of the separation channels 500 to allow introduction of the sample into the separation channel interior. The fluid interface port 17 is formed in the side wall 51 of a separation channel 500 by removing a portion of the side wall to define an opening. The fluid interface port 17 of the illustrative embodiment is formed by an aperture in the side wall of the separation channel 500 having a diameter of between about 0.1 μm and about 200 μm and preferably between about 25 μm and about 125 μm and most preferably between about 50 μm and about 100 μm. The aperture forming the fluid interface port 17 may have any suitable shape, including, but not limited to, a cylinder, a disk, a conical shape, an elliptical shape and a cubic shape. The side wall 51 or wall of the separation channel 500 can be formed by two or more components that bound the entire volume of the separation channel.

According to the illustrative embodiment of the present invention, the separation channels 500 are filled with a suitable separation medium to effect separation of a sample via application of an electric field after injection of the sample through a fluid interface port 17. Preferably, the separation medium is 0.75 percent weight/volume hydroxyethylcellulose (HEC) in a 1×TBE buffer with 1 μmethidium bromide, though one skilled in the art will recognize that any suitable medium for effecting separation of a sample may be utilized. According to one embodiment of the present invention, the separation channels may be pressure filled with a sieving matrix from the anode reservoir 180 until all of the separation channels have been filled. The anode reservoir 180 and the cathode reservoirs 120 are then filled with a 10×TBE buffer to reduce ion depletion during electrophoresis. The fluid interface ports 17 may be rinsed with deionized water.

FIG. 4A is a detailed side view of a separation channel 500 according to the illustrative embodiment, illustrating the fluid interface port 17. As shown in FIG. 4A, the fluid interface port 17 is sized and dimensioned to form a virtual wall 15 when the separation channel is filled with the separation medium 20. As used herein, “virtual wall” refers to the meniscus formed by the separation medium in the port formed in the side wall of the separation channel. The meniscus surface can be, although not required, substantially coplanar with the wall 51 of the separation channel in which the meniscus is formed. The meniscus essentially replaces the removed portion of the side wall that defines the aperture 17. The word ‘virtual’ is chosen to express the effect that the overall liquid flow through the separation channel 500 of the electrophoretic system is not influenced by the virtual wall, i.e. the flow of liquid in the micro-plate 100 having a virtual wall is substantially identical to the flow of liquid through an identical micro-plate in which no virtual wall is present. The fluid interface port 17, according to one practice, has appropriate dimensions and surface properties as to substantially not influence the overall liquid flow and liquid shape when compared to a separation channel in which no port or meniscus is formed. The virtual wall forms a direct interface between the separation channel interior and the separation channel exterior. Those of ordinary skill will readily recognize that the surface or wall of the fluid interface port can be formed anywhere along the axial height of the port. One of ordinary skill will recognize that the meniscus may be convex or concave, depending on the appropriate system pressure.

FIG. 4A further illustrates the process of introducing a sample to the separation medium 20 via the virtual wall 15 in the form of liquid droplets. As shown, a liquid sample 19a can be directly injected into the separation medium 20 within separation channel 500 through the virtual wall 15 without requiring an intermediate structure, such as a sample introduction channel or a sample reservoir. According to the illustrative embodiment, the liquid sample is introduced by forming a droplet 19b of the liquid sample 19a using a droplet generating system 185 and directing the droplet towards the virtual wall 15 with an appropriate speed and direction, indicated in FIG. 4A by velocity vector V, so as to traverse the virtual wall 15 and enter the interior of the separation channel 500. The fluid interface port 17 provides a direct interface between the separation channel interior and the exterior. According to the present invention, the interface between a separation medium 20 disposed in the micro-plate 100 and a surrounding gas phase is defined by the local absence of a solid wall in the separation channel 50, rather than by a separate channel or reservoir structure.

According to the illustrative embodiment, the lateral dimensions of the fluid interface port 17 are substantially identical to or less than the diameter of the separation channel 500, whilst the diameter of the illustrated droplet 19b is smaller than the lateral dimensions of the fluid interface port 17. The fluid interface port 17 has a dead volume that is substantially smaller when compared to conventional fluid interface ports, such as a well or a sample introduction channel. As used herein, “dead volume” refers to the volume of liquid retained in the fluid interface port 17 (i.e. the volume of liquid the fluid interface port holds that is not flushed through the fluid interface port by the flow field of the separation medium through the separation channel). The total volume of the fluid interface port 17 is defined by the area of the aperture formed in the side wall and the thickness of the side wall 51. The volume of the separation medium filling the fluid interface port 17 defines the dead volume. According to the illustrative embodiment, the fluid interface port has a dead volume that is less than about one nanoliter and preferably less than one picoliter, and most preferably about zero. Preferably, the dead volume is less than the volume of liquid sample that is injected through the fluid interface port 17.

The size of the aperture and the hydrophobicity of the fluid interface port determine the size of the dead volume. For example, the separation channel 500 shown in FIG. 4A has zero dead volume i.e. no liquid is retained in the fluid interface port 17 and a sample injected through the port 17 directly enters the separation channel interior. According to other embodiments, the separation medium may partially or totally fill the aperture, and the dead volume may be a non-zero, but substantially small, value. The dead volume also depends in whether the meniscus 15 bulges up or down, a factor that is controlled by the hydrophobicity of the port 17, the properties of the separation medium filling the separation channel 500 and the size of the aperture forming the port 17.

The relatively small dead volume provided by the virtual wall 15 results in a direct fluid interface allowing direct injection of a precise volume of sample into the interior of the separation channel 500 from the exterior of the separation channel. The ability to directly inject sample into the separation channel due to the low dead volume of the fluid interface port 17 provides improved control over the amount of sample that is injected into the separation channel 500, allows efficient use of sample, and significantly reduces waste of the sample. Furthermore, the direct injection provided by the very small dead volume reduces or prevents cross-contamination between different samples and allows a second sample to be directly injected into the system immediately after a first sample without requiring flushing of the fluid interface port 17. Conversely, in the micro-plate described in the '152 patent, which employs a separate injector structure including a sample reservoir for introducing a fluid sample to a separation channel, the dead volume is significantly large relative to the size of the separation channel. In order to introduce a fluid sample into the separation channel interior, the fluid sample must first pass through the dead volume. A larger dead volume leads to dispersion of the sample, a time delay between the time of injection and the time when the sample enters the separation channel, injection inefficiency, potential cross-contamination between different samples and difficulty controlling the amount of sample that actually reaches the separation channel. These problems are avoided or reduced by the use of the fluid interface port 17 forming a virtual wall 15 according to the illustrative embodiment The ability to directly inject a precise volume of sample into a separation channel of a separation system significantly simplifies the construction and operation of the separation system. Rather than requiring a plurality of sample reservoirs, a waste reservoir and a cross-channel, to facilitate injection of a sample, the present invention utilizes an aperture formed directly in the side wall of the separation channel to interface the sample with the interior of the separation channel. Referring back to FIG. 3, the injection region 110 of the micro-plate 100 is significantly simplified in comparison with the micro-plate injector shown in FIG. 1. The fluid interface port of the illustrative embodiment provides improved control over the volume of sample that is introduced into the separation channel while simultaneously simplifying the overall structure of the system, providing a more compact micro-plate and allowing a larger number of samples to be processed. The fluid interface port 17 of the illustrative embodiment of the present invention further allows another sample to be directly injected into the separation channel 500 after a first sample without risk of contamination. Conversely, the micro-plate of the '152 patent requires separate sample reservoirs on the plate, which are activated at different times, for each different sample, in order to process different samples.

In the embodiment of FIG. 3, the number of holes H in the micro-plate 100 is significantly reduced over the micro-plate described in the '152 patent. Each separation channel 500 of the illustrative embodiment requires only one opening forming a fluid interface port 17 to allow introduction and separation of a sample and the micro-plate 100 further includes openings for the cathodes and for the anode. Conversely, the number of holes in the micro-plate 10 of the '152 patent is 5N/4+7, due to the increased number of holes required for sample introduction via the injector 11. The reduction in holes formed in the micro-plate 100 provided by the illustrative embodiment increases manufacturing efficiency and further decreases the potential for defects in the production of micro-plates, as caused by mechanical stress associated with the drilling process. Furthermore, multiplexing the cathode 120 and anode 180 with a plurality of separation channels 500 allow a greater number of separation channels 500 to fit in a single substrate. The reduced size of the fluid interface port 17 also provides a more compact structure, allows even greater number of separation channels 500 to fit on a single substrate. The above advantages are also applicable when the holes are formed by a molding process or a bonding process in lieu of the drilling process.

Samples may be loaded manually or automatically into the separation channels 500 in the micro-plate 100 via the virtual walls 15. Serial injections may be used to increase the sample throughput with a predetermined number of capillaries. According to one embodiment, a separation channel may have a plurality of fluid interface ports forming virtual walls to allow introduction of a plurality of samples into the separation channel 500. Further, an increase in the number of capillaries on the CAE micro-plate 100 would increase the throughput correspondingly without introducing any sample contamination. A particular advantage of using virtual walls to interface fluids with the micro-plate 100 is that a different sample can be injected directly after a first sample without requiring flushing of the fluid interface port 17.

For example, the sample droplets may be formed and dispensed using any suitable droplet generating system 185, such as a multi-headed pipetter or the droplet dispensing systems described in U.S. Provisional Patent Application Number 60/325,001, filed Sep. 25, 2001 and entitled “Two-Pin Liquid Sample Dispensing System”, the contents of which are herein incorporated by reference, and U.S. Provisional Patent Application Number 60/325,040 entitled “Droplet Dispensing System”, the contents of which are herein incorporated by reference. One skilled in the art will recognize that any suitable droplet generating system may be utilized to form and dispense droplets of a sample to a separation device according to the illustrative embodiment of the present invention.

FIG. 4B shows a cross-sectional view perpendicular to the separation channel 500 at the location of the fluid interface port 17, illustrating the process of introducing the liquid sample 19a to be separated into the separation medium through the virtual wall 15. As illustrated in FIG. 4B, the droplet generating system 185 comprises a droplet carrying element 181 for carrying the droplet. According to the illustrative embodiment, the droplet carrying element 181 can comprise a pin, as described in U.S. Provisional Patent Application 60/325,001 filed Sep. 25, 2001 and entitled “Two-Pin Liquid Sample Dispensing System”, and U.S. Provisional Patent Application Number 60/325,040 entitled “Droplet Dispensing System”, for introducing the droplet to the separation channel 500 by contacting the virtual wall 15.

FIG. 4C shows a cross-sectional view of the separation channel 500 immediately after injection of the liquid sample 19a in the separation medium 20. As illustrated, the liquid sample 19a forms a well defined band 190 having a precise volume in the separation medium 20. According to an alternate embodiment, the liquid sample dissolves, merges or mixes into the separation medium 20. After introduction via the virtual wall 15, the liquid sample 19a is transported through the separation channel by the separation medium 20 by applying an electric field across the separation channels 500 in the micro-plate 100, to be described in detail below.

The fluid interface port 17 disposed in the separation channel side wall 51 and forming a virtual wall 15 may have any suitable shape, such as a cylindrical or conical shape, having a suitably low dead volume for providing direct access to the separation channel interior. According to one embodiment, shown in FIG. 4D, the inner wall 63 of the fluid interface port 17 is formed of or coated with a material that is repellant for the separation medium 20 to repel the separation medium from the opening 17. According to a preferred embodiment, the inner wall 64 of the separation channel 500 is attractive for the separation medium 20, to retain the separation medium 20 inside the separation channel 500. The liquid repellent section in the fluid interface port 17 prevents liquid from leaking out of the micro-plate 10 and ensures the repeatable formation of a virtual wall 15 in the fluid interface port 17 when the separation channel is filled with the separation medium 20. The use of an inner wall 64 that is attractive for the separation medium 20 further enhances automatic, passive capillary filling of the separation channel 500 with the separation medium 20. As a result of capillary forces, the separation channel 500 may be automatically filled without requiring application of external energy or pressure sources, such as pumps or pressure chambers.

FIG. 4E illustrates an embodiment where the separation channel 500 and virtual wall 15 are covered with a covering layer 66. According to the illustrative embodiment, the covering layer 66 comprises a liquid layer that is immiscible with the separation medium 20 in the separation channel. The covering layer prevents the evaporation of the separation medium 20 from the separation channel through the opening 17, while still allowing the injection of a liquid sample, such as liquid 19a, into the separation channel 500 through the covering layer 66 and the virtual wall 15.

According to an alternate embodiment, as shown in FIG. 4F, the fluid interface port in the separation channel 500 is formed by an array 72 of openings 17, each forming a virtual wall 15 upon filling of the separation channel 500 with the separation medium 20. The virtual walls 15 in the array 72 are disposed in close proximity to each other, thereby allowing the injection of liquid via a wicking process, as illustrated in FIG. 4G. To introduce a liquid sample into the separation channel 500, as shown in FIG. 4G, a selected amount of the liquid sample 19a is deposited on top of the array 72, such that the capillary forces wick the liquid sample into the separation channel 500. According to a preferred embodiment, the inner walls 63 of the fluid interface port 17 are rendered repellant to the separation medium 20 whilst the outer surfaces of the fluid interface ports 17 preferably are rendered attractive to the liquid sample 19a. The use of an array of openings to form an array of virtual walls reduces the necessity and criticality of precisely targeting the droplets 19b towards a particular virtual wall. The droplets need only to be aimed in the direction of the array, allowing capillary forces to pull droplets into the channel interior. The velocity and direction of the propelled droplets are also not as important to achieve injection of the sample into the separation channel 500.

According to yet another embodiment of the invention, a plurality of openings are disposed in the side wall 51 of the separation channel 500 to allow for the introduction or ejection of liquid via a virtual wall at a plurality of locations in the separation channel. For example, the separation channel 500 can include multiple fluid interface ports 17 positioned across or along the width of the separation channel 500 to define a plurality of virtual walls 15 to allow for simultaneous or sequential introduction of a plurality of liquids. In this manner, an increased volume of liquid may be immediately injected into the separation channels via the plurality of virtual walls. The use of a plurality of virtual walls across the separation channel width further allows for simultaneous introduction and mixing of a plurality of different liquids. Alternatively, the separation channel 500 may include a plurality of virtual walls disposed along the length of the separation channel to allow for sequential introduction of liquids into the separation channel, or ejection of a liquid from the separation channel along different locations in the fluid flow path.

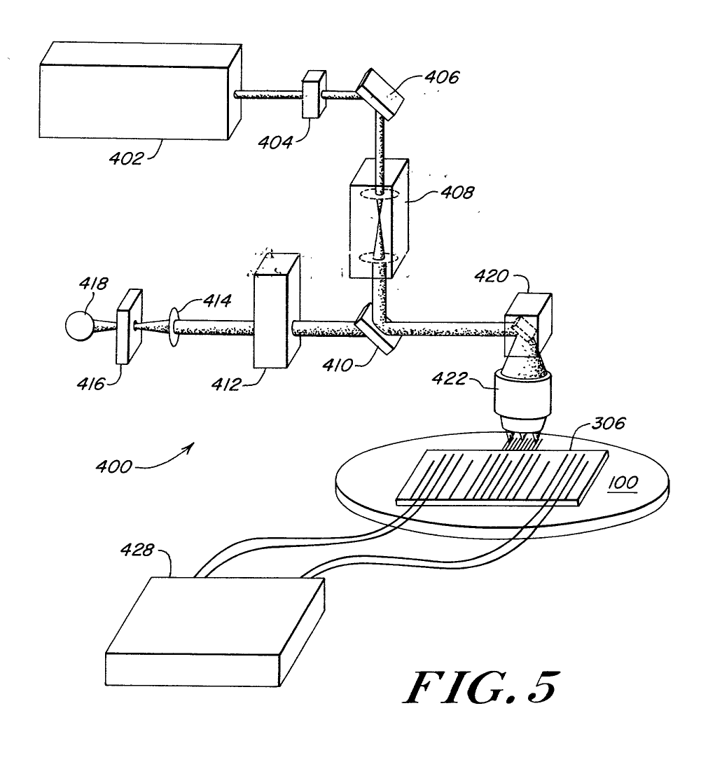

FIG. 5 illustrates an electrokinetically operated system 400 comprising the micro-plate 100 of FIG. 3 according to an illustrative embodiment of the present invention. According to the illustrative embodiment shown in FIG. 5, the micro-plate 100 is coupled to an electrode array 306 to provide electrical contact with a plurality of solutions in a combination of the fluid interface ports 17, the cathode reservoirs 120 and the anode reservoirs 180. The electrode array 306 is fabricated by placing an array of conductors such as platinum wires through a printed circuit board. Each conductor is adapted to engage a fluid interface port 17 or a reservoir 120 or 180 on the micro-plate 100. Moreover, the wires are electrically connected with metal strips on the circuit board to allow individual fluid interface ports of a common type to be electrically addressed in parallel. The electrode array 306 also reduces the possibility of buffer evaporation through the virtual walls. The electrode array 306 in turn is connected to one or more computer controlled power supplies 428.

After assembly, the illustrative CAE micro-plate 100 is probed with a galvo-scanner system 400, including a laser-excited galvo-scanner. The system 400 measures fluorescence using a detector at a detection zone of the separation channels 500. During the process of electrophoresis, as a fluorescent species traverses a detection zone, it is excited by an incident laser beam. In a direct fluorescence detection system, either the target species is fluorescent, or it is transformed into a fluorescent species by tagging it with a fluorophore. The passing of the fluorescent species across the detection zone results in a change, typically an increase in fluorescence that is detectable by the system 400.

The illustrative galvo-scanner 400 may have a frequency-doubled YAG laser 402, such as YAG laser available from Uniphase Corporation of San Jose, Calif. The YAG laser generates a beam which may be a 30 mW, 532 nm beam. The beam generated by the laser 402 travels through an excitation filter 404 and is redirected by a mirror 406. From the mirror 406, the beam travels through a beam expander 408. After expansion, the beam is directed to a dichroic beam splitter 410. The laser beam is directed to a galvanometer 420 which directs the beam to a final lens assembly 422. In this manner, the beam is focused on a spot of about 5 μm where it excites fluorescence from the molecules in the channels and is scanned across the channels at 40 Hz. The resulting fluorescence is gathered by the final lens and passed through the galvomirror and the dichroic beam splitter 410 to an emission filter 412 which operates in the range of about 545-620 nm. After passing through the emission filter 412, the beam is focused by a lens 414. Next, the beam is directed through a pinhole 416 such as a 400 μm pinhole for delivery to a photomultiplier (PMT) 418.

As shown, the electrode array 306 may be connected to one or more power supplies 428, such as a series PS300, available from Stanford Research Systems of Sunnyvale, Calif. The power supplies are connected to a computer and software controlled to automatically time and switch the appropriate voltages into the electrode array 306. The software may be written in a conventional computer language, or may be specified in a data acquisition software such as LabVIEW, available from National Instruments of Austin, Tex. Data corresponding to spatially distinct fluorescent emission may then be acquired at about 77 kHz using a 16 bit A/D converter from Burr-Brown Corporation of Tucson, Ariz. Logarithmic data compression is then applied to generate five linear orders of dynamic measurement range. The data is obtained as a 16-bit image, and electropherograms are then generated using a suitable software such as IPLab, available from Signal Analytics, Vienna, Va., to sum data points across each channel.

As shown, the illustrative electrokinetically operated system 400 comprises a compact structure, which allows a plurality of different reactions and processes to occur on a relatively small substrate. The use of openings forming virtual walls 15 to define fluid interface ports 17 in the side walls of the parallel separation channels 500 allows direct interfacing of liquid samples with the separation channels 500, improves injection efficiency, provides easy control over the volume of liquid introduced into the system 400, substantially reduces the size of the micro-plate, reduces waste, and facilitates introduction of a liquid sample to a separation channel.

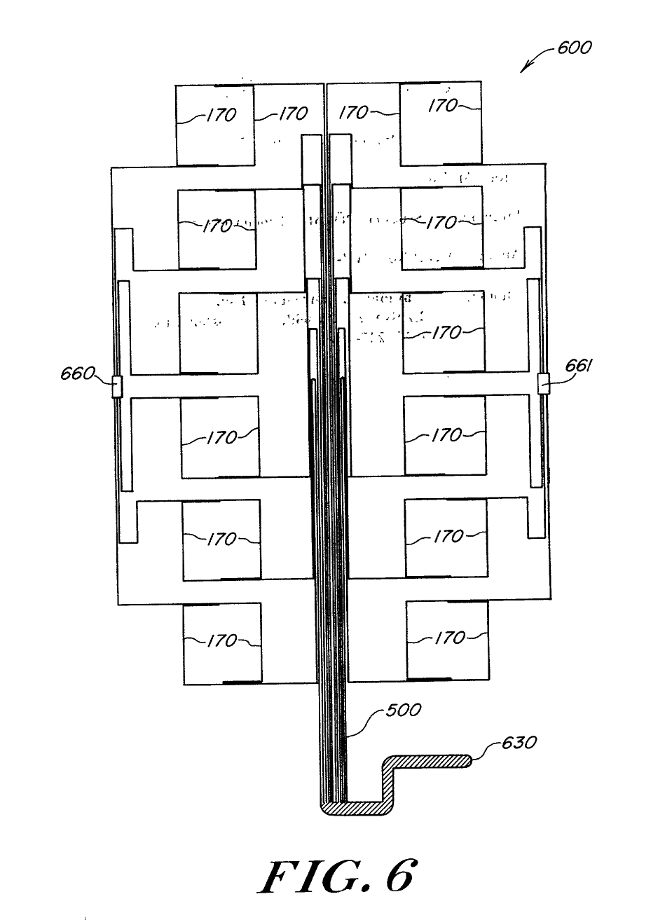

Referring to FIG. 6, a second embodiment of a CAE micro-plate 600 for performing a separation of a sample according to an illustrative embodiment of the present invention is shown. In FIG. 6, the micro-plate 600 includes an array of separation channels 500 for separating a liquid sample into different components under the influence of an electric field. Each separation channel 500 includes one or more fluid interface ports 170 defined by openings in the side wall of the separation channels forming virtual walls. Each separation channel 500 is connected to one of two cathode reservoirs 660 or 661, respectively. The separation channels 500 are connected to an anode 630.

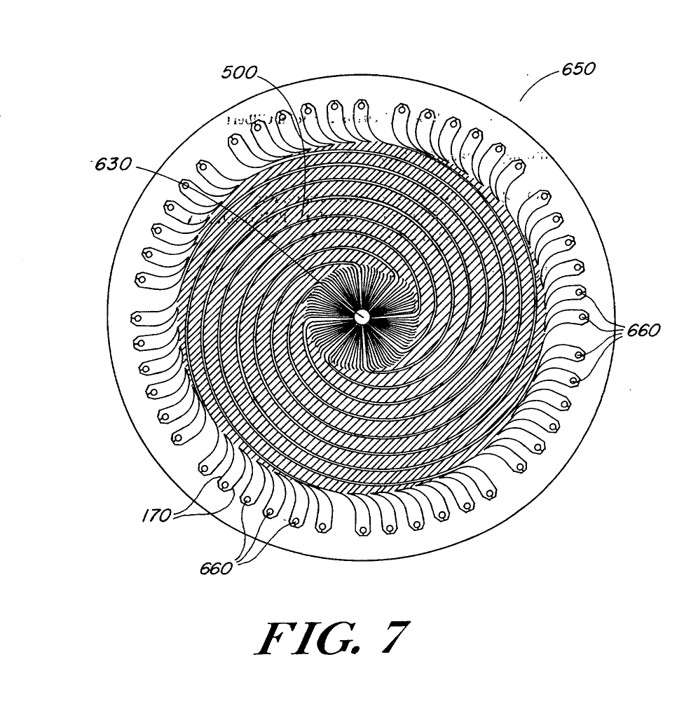

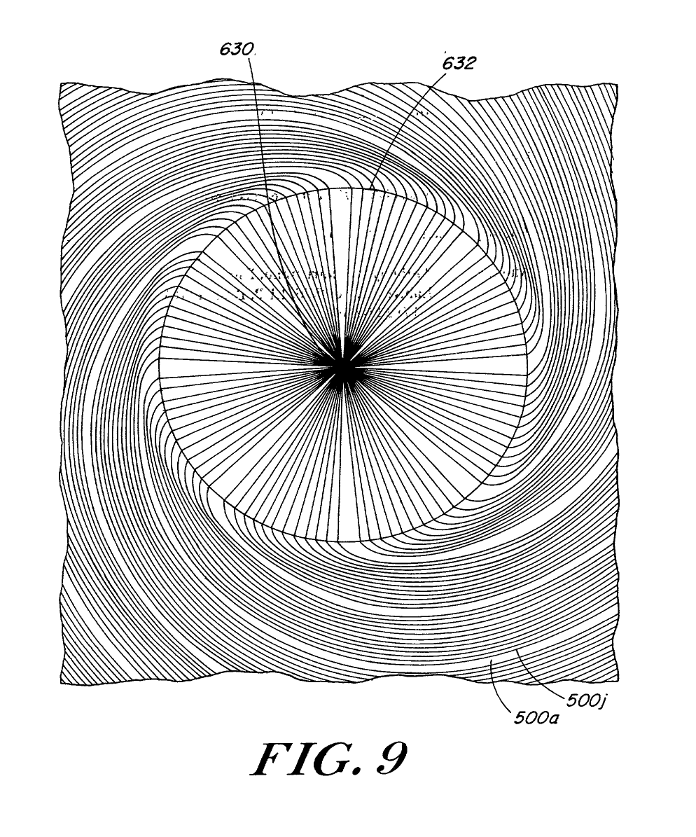

Referring now to FIG. 7, a third embodiment of a CAE micro-plate 650 for performing a separation of a sample according to the teachings of the present invention is disclosed. In the CAE micro-plate 650 of FIG. 7, cathode reservoirs 660 are positioned on a perimeter of the CAE micro-plate 650. Additionally, an anode reservoir 630 is positioned in the center of the CAE micro-plate 650. Separation channels or capillaries 500 may emanate from an outer perimeter of the micro-plate 650 toward the center of the micro-plate 650 in a spiral pattern if longer separation channels are desired. Alternatively, if short paths are desired, the separation channels 500 or capillaries may simply be a straight line connecting the perimeter of the micro-plate 650 to the center 632 of the CAE micro-plate 650 shown in FIG. 9. Fluid interface ports 170 are provided in the side walls of the separation channels 500 at the perimeter of the micro-plate 650 to facilitate insertion of a sample to the micro-plate.

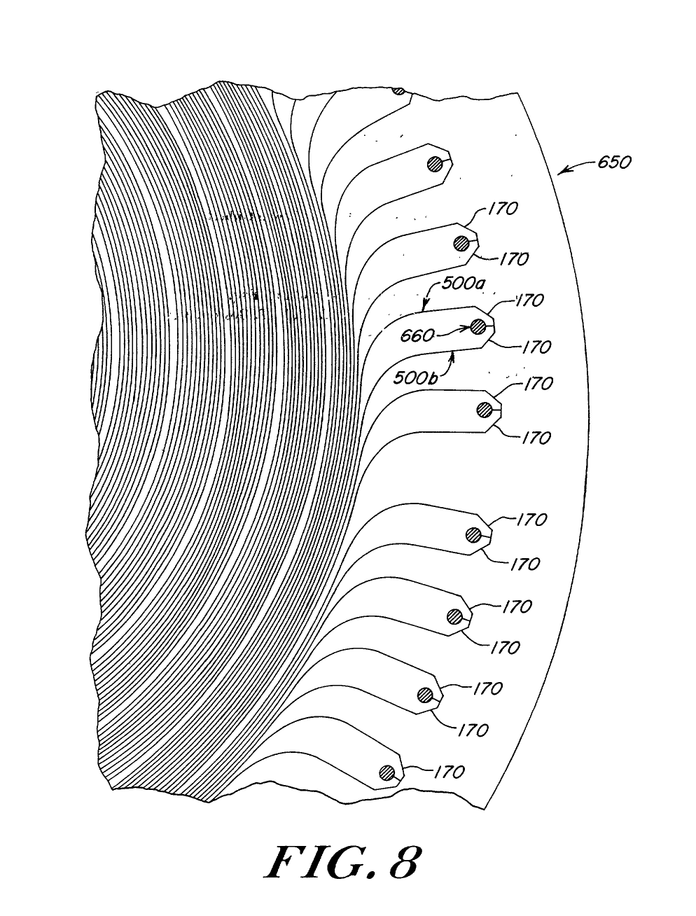

Turning now to FIG. 8, an injection region, including a fluid interface port 170 formed in the side wall of a separation channel according to the teachings of the illustrative embodiment of the present invention, of the CAE micro-plate 650 of FIG. 7 and its position on a perimeter of the micro-plate of FIG. 7 are illustrated in detail. In FIG. 8, two separation channels or capillaries 500a and 500b are connected to a common cathode reservoir 660. Additionally, the separation channels 500a and 500b include fluid interface ports 170 formed in a side wall therein. As described above, the fluid interface ports are defined by openings in the side wall of each of the separation channels 500a and 500b to allow for the interfacing of a liquid sample and the separation medium. The openings are sized and dimensioned such that the separation medium forms a virtual wall 15 in the fluid interface port 170.

Referring now to FIG. 9, the common anode 630 of the illustrative micro-plate of FIG. 7 is shown in detail. As shown in FIG. 9, a plurality of separation channels or capillaries 500a-500j form a curvilinear pattern, which may be a radial pattern, converging on a central region 632. From the central region 632, the separation channels or capillaries form a passageway from the perimeter of the central region 632 to the common anode reservoir 630 at the center of the CAE micro-plate. The center area 630 is the area where a rotating scanner may be used for detection purposes.

In addition, the scanning detection system may be altered by inverting the objective lens and scanning from below. Placing of the optics below the plate would facilitate manipulation and introduction of samples. The inverted scanning would also avoid spatial conflict with the anode reservoir, thereby permitting a central placement of the anode. Moreover, an array of PCR reaction chambers may be used with the micro-plate or other separation system of the invention to allow for integrated amplification of low volume samples, eliminate sample handling and manual transfer, and reduce cost. Furthermore, the present invention contemplates that electronic heaters, thermocouples and detection systems may be used with an array of microfluidic capillaries to enhance the separation process.

The use of a virtual wall in a separation channel side wall to create a fluid interface port for a separation system provides significant advantages over conventional fluid interfaces. The fluid interface port comprising a virtual wall is relatively simple to manufacture, is compact, provides high ejection efficiency, does not adversely affect operation/flow, can be made bidirectional and is useful for a variety of applications. The illustrative embodiment eliminates the need for a separate sample introduction structure, such as a sample channel or a sample reservoir, and permits direct injection of a sample into a separation channel. The use of a fluid interface port forming a virtual wall further allows a more compact separation device, increases the number of samples that can be processed, provides enhanced control over the introduction of the sample to a separation channel, facilitates and simplifies the introduction process, reduces waste and conserves resources overall.

The present invention has been described relative to an illustrative embodiment in a capillary array electrophoretic device. One skilled in the art will recognize that the invention is not limited to a capillary array electrophoresis micro-plate and that a fluid interface port comprising a virtual wall may be implemented in any suitable separation system including, but not limited to, an electrochromatographic system, a pressure-driven chromatographic system and an isoelectric focussing system, according to the teachings of the present invention. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and protected by Letters Patent is:

1. A separation device, comprising:
one or more anode reservoirs;
a plurality of separation channels connected to said anode reservoirs, each of said separation channels having an interior bounded by a side wall;
one or more fluid interface ports formed in the side wall of one of said separation channels to provide access to the interior of the separation channel, wherein a separation medium disposed in the interior of the separation channel forms a virtual wall at the fluid interface port; and
at least one cathode reservoir multiplexed with two or more of said separation channels.

2. The device of claim 1, further comprising an electrode array coupleable to said reservoirs and said fluid interface ports.

3. The device of claim 1, wherein the device has an outer perimeter and a center and the separation channels connect the outer perimeter to the center.

4. The device of claim 1, wherein the fluid interface port has a dead volume that is less than about one nanoliter.

5. The device of claim 1, wherein the fluid interface port has zero dead volume.

6. The device of claim 1, wherein the fluid interface port comprises an array of apertures forming virtual walls.

7. The device of claim 1, wherein the fluid interface port has a diameter between about 25 μm and about 125 μm.

8. The separation device of claim 1, wherein the device is a capillary array electrophoresis plate.

9. The separation device of claim 1, wherein the device comprises an electrochromatographic system.

10. The separation device of claim 1, wherein the device comprises a pressure-driven chromatographic system.

11. The separation device of claim 1, wherein the device comprises an isoelectric focusing system.

12. A separation device, comprising:
an array of microfabricated separation channels formed at a surface of a first microfabricated substrate and a corresponding surface of a second substrate bonded to the surface of said first substrate, each of said channels having an interior bounded by a side wall, a first end and a second end;
an array of fluid interface ports formed in the side walls of said separation channels to provide access to the interiors of the separation channels, wherein a separation medium disposed in the interior of the separation channel forms a virtual wall at each of the fluid interface ports in the array;
an array of cathode reservoirs connected to the first end of each of the separation channels; and
an array of anode reservoirs, wherein at least one anode reservoir is connected to the respective second ends of at least two of the separation channels.

13. The separation device of claim 12, wherein the fluid interface port has a diameter between about 25 μm and about 125 μm.

14. The separation device of claim 12, wherein the first and second substrate are made of glass.

15. The separation of claim 12, wherein the first and second substrate are made of plastic.

16. The separation device of claim 12, further comprising an electrode array coupleable to said reservoir array layer.

17. The separation device of claim 16, wherein said electrode array is integral with the two substrates.

18. The separation device of claim 17, wherein the fluid interface ports are regularly spaced on one of said substrates to receive solutions from a parallel loading device.

19. The separation device of claim 12, wherein the first substrate includes an array of electrodes aligned with the fluid interface ports, the cathode reservoirs, and the anode reservoirs to make electrical contacts with a plurality of solutions in a combination of the fluid interface ports, the cathode reservoirs, and the anode reservoirs.

20. The separation device of claim 12, wherein the separation device has H holes, and wherein H is approximately equal to the number of samples to be simultaneously processed in the separation device.

21. The separation device of claim 12, wherein the separation device is made of a combination of glass and plastic.

22. The separation device of claim 12, further comprising an electrode array in electrical contact with the separation device.

23. The separation device of claim 12, wherein a plurality of fluid interface ports are disposed in one of said separation channels.

24. The separation device of claim 12, wherein the first substrate includes an array of electrodes aligned with the fluid interface ports to make electrical contacts with a plurality of solutions in the fluid interface ports.

25. The separation device of claim 12, wherein the fluid interface port has a diameter between about 25 μm and about 125 μm.

26. The separation device of claim 12, wherein the device is a capillary array electrophoresis plate.

27. The separation device of claim 12, wherein the device comprises an electrochromatographic system.

28. The separation device of claim 12, wherein the device comprises a pressure-driven chromatographic system.

29. The separation device of claim 12, wherein the device comprises an isoelectric focusing system.

30. A separation device, comprising:
a substrate;
a plurality of separation channels formed in said substrate, each of said separation channels having an interior bounded by a side wall;
a plurality of fluid interface ports formed in the side walls of said separation channels to provide access to the interior of the separation channel, wherein a separation medium disposed in the interior of the separation channel forms a virtual wall at the fluid interface port and wherein each separation channel of the plurality of separation channels includes at least one dedicated fluid interface port; and
an anode reservoir multiplexed to two or more of the plurality of separation channels.

31. The separation device of claim 30, wherein the fluid interface port has a diameter between about 25 μm and about 125 μm.

32. A separation device, comprising:
a substrate;
a plurality of separation channels formed in said substrate, each of said separation channels having an interior bounded by a side wall;
a plurality of fluid interface ports formed in the side walls of said separation channels to provide access to the interior of the separation channel, wherein a separation medium disposed in the interior of the separation channel forms a virtual wall at the fluid interface port and wherein each separation channel of the plurality of separation channels includes at least one dedicated fluid interface port; and
a cathode reservoir multiplexed to two or more of the plurality of separation channels.

33. The separation device of claim 32, wherein the fluid interface port has a diameter between about 25 μm and about 125 μm.

34. The device of claim 32, further comprising an array of electrodes coupled to the substrate.

35. The device of claim 32, wherein said plurality of fluid interface ports are regularly spaced in said substrate and adapted to engage a parallel loading device.

36. The device of claim 35, wherein the parallel loading device comprises a multi-headed pipetter.

37. The separation device of claim 36, wherein the parallel loading device comprises a pin for carrying and introducing the droplet of a liquid sample to the fluid interface port by contacting the virtual wall.

38. The separation device of claim 32, wherein the separation channels are disposed in a radial pattern on the separation device.

39. A method for injecting a liquid sample through a separation device, comprising the steps of:
connecting a cathode reservoir to respective first ends of two or more separation channels;
connecting an anode reservoir to respective second ends of two or more of said separation channels;
forming a droplet from the liquid sample;
directing the droplet to a virtual wall formed by a separation medium in a fluid interface port formed in a side wall of a separation channel; and
applying a voltage to the fluid interface port to draw the sample into the separation channel.

40. A method of forming a separation device for separating a sample into different components, comprising the steps of:
forming a plurality of separation channels in said separation device, each of said separation channels defined by an interior bounded by a side wall;
forming a plurality of fluid interface ports in the side walls of said separation channels to provide access to the interior of the separation channels, wherein each fluid interface port forms a virtual wall when the separation channels are filled with a separation medium; and
connecting an anode reservoir to two or more of the plurality of separation channels.

41. The method of claim 40, wherein the step of forming a plurality of fluid interface ports comprises removing portions of said side walls to define an aperture having a diameter between about 25 μm and about 125 μm.

42. The method of claim 40, wherein the separation channels are disposed in a radial pattern on the separation device.

43. A method of forming a separation device for separating a sample into different components, comprising the steps of:
forming a plurality of separation channels in said separation device, each of said separation channels defined by an interior bounded by a side wall;
forming a plurality of fluid interface ports in the side walls of said separation channels to provide access to the interior of the separation channels, wherein each fluid interface port forms a virtual wall when the separation channels are filled with a separation medium; and
connecting a cathode reservoir to two or more of the plurality of separation channels.

44. The method of claim 43, wherein the step of forming a plurality of fluid interface ports comprises removing portions of said side walls to define an aperture having a diameter between about 25 μm and about 125 μm

45. The method of claim 43, wherein the separation channels are disposed in a radial pattern on the separation device.
